(19) United States
(12) Patent Application Publication
(10) Pub. No.: US 2014/0047178 A1
(43) Pub. Date: Feb. 13, 2014

(54) STORAGE SYSTEM AND STORAGE CONTROL METHOD

(71) Applicant: FUJITSU LIMITED, Kawasaki-shi (JP)

(72) Inventor: Kunihiko KASSAI, Yokohama (JP)

(73) Assignee: FUJITSU LIMITED, Kawasaki-shi (JP)

(21) Appl. No.: 13/953,867

(22) Filed: Jul. 30, 2013

(30) Foreign Application Priority Data
Aug. 13, 2012 (JP) 2012-179480

(51) Int. Cl. G06F 3/06

(52) U.S. Cl. CPC G06F 3/0689; G06F 3/0634; G06F 3/0616
USPC 711/114

(57) ABSTRACT

A storage system includes: a grouping unit configured to generate one or more storage device sub-groups, each of the storage device sub-groups including a storage device used to store data, from storage devices included in a plurality of storage device groups that respectively include a plurality of storage devices; a selection unit configured to select any of the one or more storage device sub-groups; and a control unit configured to shut off power supply to a non-selected device group, which is a storage device sub-group other than a selected storage device sub-group and included in a storage device group including the selected storage device sub-group, and shut off power supply to storage devices included in a storage device group other than the storage device group including the selected storage device sub-group.

### CROSS-REFERENCE TO RELATED APPLICATION

This application is based upon and claims the benefit of priority of the prior Japanese Patent Application No. 2012-179480, filed on Aug. 13, 2012, the entire contents of which are incorporated herein by reference.

### FIELD

The embodiments discussed herein are related to a storage system, a storage control method, and a program for a storage control.

### BACKGROUND

A disk array device is frequently used as a storage system. The disk array device is a storage device including a plurality of magnetic storage devices such as a hard disk. The disk array device manages a plurality of magnetic storage devices as one RAID (Redundant Array of Inexpensive Disks) group with a RAID technique. To a RAID group, one or more logical volumes are allocated, and data locations are decided.

Additionally, an idea called “aggregate” that handles a plurality of RAID groups as one logical pool in order to increase an upper limit of a storage capacity that can be provided to a host is known.

In relation to the above described techniques, a storage system that reduces power needed for storage resources allocated to a pool and avoids the lifetime of the storage resources from being shortened in a storage system implemented with an AOU (Allocation on Use) technique is known. In this storage system, a storage device defined as belonging to a pool is allocated to a virtual volume. The storage device is powered off before the device is allocated to a virtual volume, and powered on when the device is allocated to the virtual volume.

Additionally, a storage control device for selecting a physical storage device where a logical storage device is arranged depending on whether a type of an access pattern to a logical volume of a higher-level device is either a random access or a sequential access, and a first performance index preset in the logical volume is known.

Furthermore, a computer system for preventing the performance of a virtualized storage system from being degraded is known. This computer system includes a storage device, a host computer, and a management computer. The management computer provides storage resources to the host computer based on storage configuration information obtained from the storage device. Moreover, the management computer obtains use information of the hardware resource including storage resources, and decides the configuration of the storage device in order to prevent a load from concentrating on a particular hardware resource based on the use information of the hardware resource.

Note that related art is described, for example, Japanese Laid-open Patent Publication No. 2007-293442, Japanese Laid-open Patent Publication No. 2008-123132 and Japanese Laid-open Patent Publication No. 2008-165620.

### SUMMARY

According to an aspect of the embodiments, a storage system includes: a grouping unit configured to generate one or more storage device sub-groups, each of the storage device sub-groups including a storage device used to store data, from storage devices included in a plurality of storage device groups that respectively include a plurality of storage devices; a selection unit configured to select any of the one or more storage device sub-groups; and a control unit configured to shut off power supply to a non-selected device group, which is a storage device sub-group other than a selected storage device sub-group and included in a storage device group including the selected storage device sub-group, and shut off power supply to storage devices included in a storage device group other than the storage device group including the selected storage device sub-group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of configuration of a storage system according to an embodiment;

FIG. 2 illustrates an example of a configuration of a storage system according to another embodiment;

FIG. 3 is an explanatory diagram of operations of a disk control unit;

FIG. 4 is an explanatory diagram of operations of a data control unit;

FIG. 5 illustrates an example of an aggregate management table;

FIG. 6 illustrates an example of a RAID management table;

FIG. 7 illustrates an example of a disk group management table;

FIG. 8 illustrates an example of a write management table;

FIG. 9 is a flowchart illustrating a disk group generation process executed by the disk control unit;

FIG. 10 is a flowchart illustrating a write process executed on the data control unit;

FIG. 11 is a flowchart illustrating a write process executed on the disk control unit;

FIG. 12 is an explanatory diagram for parity generation at a data write in step S1102;

FIG. 13 illustrates an example of an aggregate including a RAID group of RAID 4;

FIG. 14 illustrates an example of a RAID management table;

FIG. 15 illustrates an example of an aggregate including a RAID group of RAID 0+1;

FIG. 16 illustrates an example of a RAID management table;

FIG. 17 illustrates an example of a disk group management table; and

FIG. 18 illustrates an example of a write management table.

### DESCRIPTION OF EMBODIMENTS

In the above described storage control device for selecting a physical storage device depending on the type of an access pattern and the first performance index, stored data is distributed and a plurality of disks to be accessed are needed when a RAID group is distributed and arranged according to an access from a host. Accordingly, the number of disks made to continuously run increases, leading to excessive power consumption.

Additionally, in the above described computer system for preventing the performance of a virtualized storage system from being degraded, access data is distributed and arranged to select a logical device according to an access from a host, so that excessive power is consumed due to an increase in the number of disks made to continuously run.

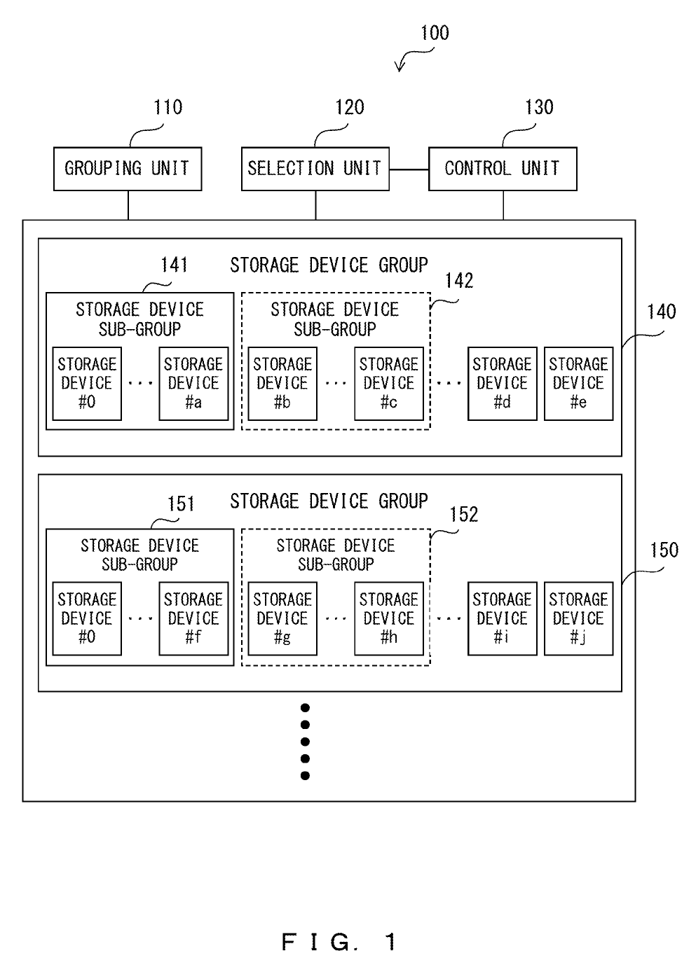

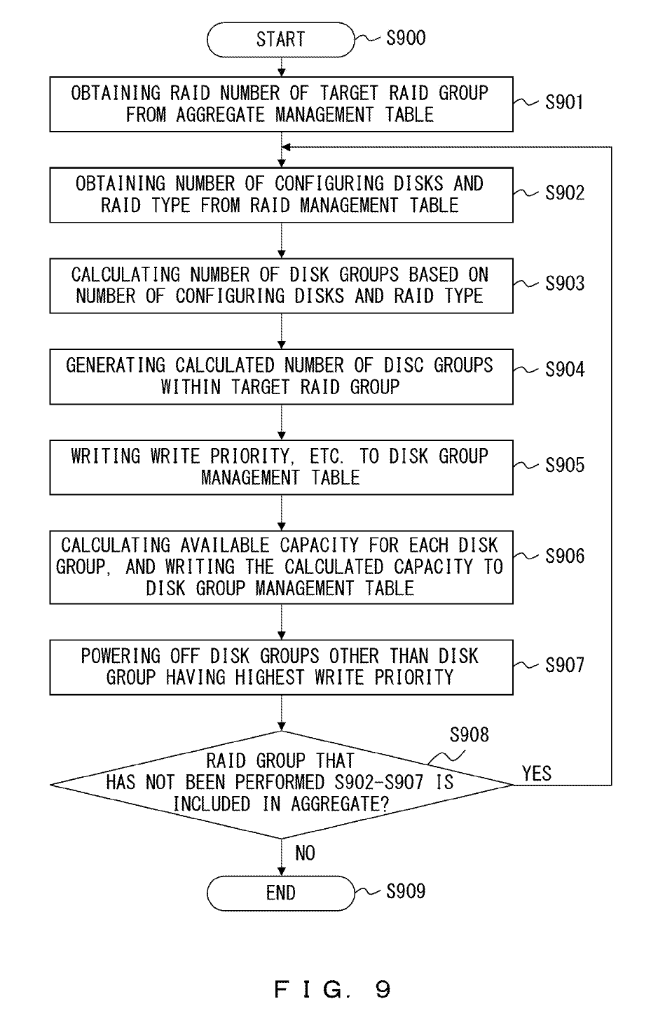

Embodiments according to the present invention are described below with reference to FIGS. 1-18. The embodiments described below are merely examples, and do not preclude various modifications and technical applications, which are not explicitly recited below. Namely, the embodiments may be carried out by being variously modified within a scope that does not depart from the gist of the invention. Process procedures represented by flowcharts illustrated in FIGS. 9-11 are not intended to limit the order of processes. Accordingly, the order of processes may be changed if possible.

FIG. 1 illustrates an example of configuration of a storage system 100 according to an embodiment. The storage system 100 includes a grouping unit 110, a selection unit 120, a control unit 130, and a plurality of storage device groups 140, 150, . . . .

Each of the storage device groups 140, 150, . . . includes a plurality of storage devices, each of which can be operated as one storage device like a RAID group. For example, the storage device group 140 includes storage devices, such as storage devices #0, . . . , #a, #b, . . . , #c, and the like, used to store data, and storage devices, such as storage devices #d, #e and the like, used to store information other than data, for example, parity information. In this case, the storage device group 140 is operable as a RAID-DP (RAID Double Parity).

The grouping unit 110 generates one or more storage device sub-groups by dividing, into groups, storage devices used to store data among storage devices included in the plurality of storage device groups 140, 150, . . . . FIG. 1 illustrates the case where the grouping unit 110 generates storage device sub-groups such as a storage device sub-group 141 including the storage devices #0, . . . , #a, and a storage device sub-group 142 including the storage devices #b, . . . , #c.

The selection unit 120 selects any of storage device sub-groups generated by the grouping unit 110, such as the storage device sub-groups 141, 142, 151 and 152 in FIG. 1. It is assumed below that the selection unit 120 selects the storage device sub-group 141.

The control unit 130 performs a control such that power is not supplied to storage device sub-groups other than the selected storage device sub-group 141, which are included in the storage device group 140 including the storage device sub-group 141 selected by the selection unit 120. In other words, the control unit 130 shuts off power supply to a non-selected storage device sub-group within the storage device group 140 including the selected storage device sub-group 141. In FIG. 1, power is not supplied to the storage device sub-group 142 within the storage device group 140. The control unit 130 further performs a control such that power is not supplied to storage devices included in a storage device group, such as the storage device group 150 of FIG. 1, other than the storage device group 140 including the selected storage device sub-group 141. In other words, the control unit 130 shuts off power supply to storage devices within the storage device group 150 which does not include the selected storage device sub-group 141.

As described above, the storage system 100 performs a control such that power is not supplied to storage device sub-groups other than a selected storage device sub-group, which are included in a storage device group including the selected storage device sub-group selected by the selection unit 120. Moreover, the storage system 100 performs a control such that power is not supplied to storage devices included in a storage device group other than the storage device group including the selected storage device sub-group. As a result, the storage system 100 can reduce power consumed by the storage system 100.

The above provided description has referred to the case where the storage device group 140 operates as a RAID-DP. For example, if only the storage device #e is used to store parity information, the storage device group 140 can operate as a RAID 4. Moreover, for example, if all storage devices are used to store data, the storage device group 140 can operate as RAID 0+1.

a, b, c, and d, which are illustrated in FIG. 1, are integers that are equal to or larger than 1 and have a relationship of a<b<c<d. Similarly, e, f, g, and h are integers that are equal to or larger than 1 and have a relationship of e<f<g<h.

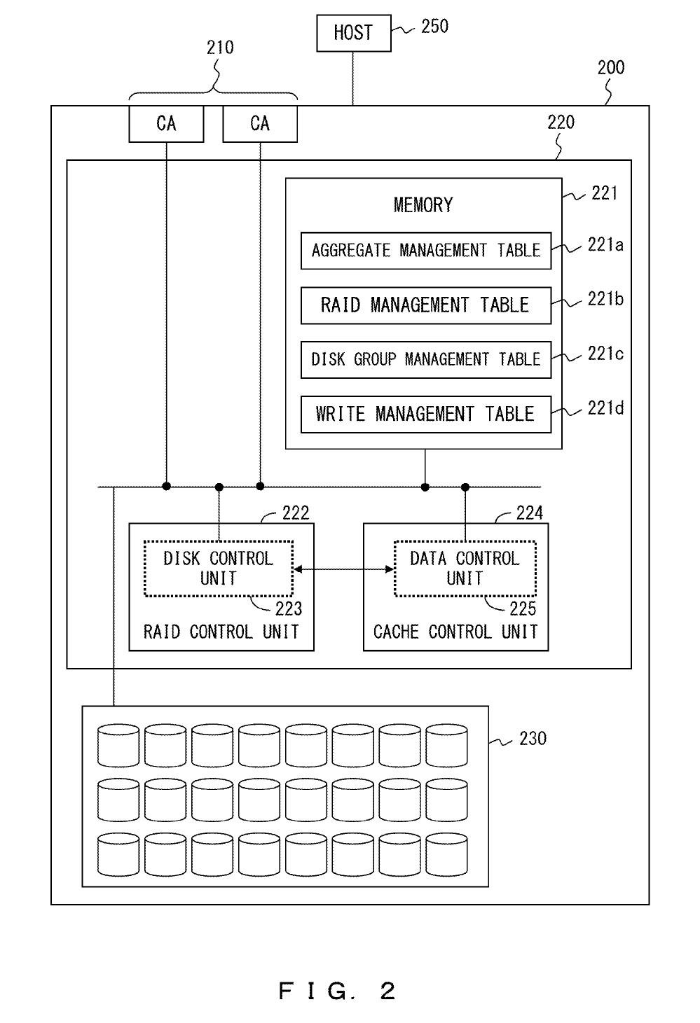

FIG. 2 illustrates an example of a configuration of a storage system 200 according to another embodiment. The storage system 200 includes CAs (Channel Adapters) 210, which are interfaces for communicatively connecting to a host 250 that is a higher-level device of the storage system 200, a control device 220 for controlling the storage system 200, and a disk group 230 including a plurality of storage devices. The storage system 200 and the host 250 are communicatively connected via a network, a dedicated line, or the like.

The control device 220 includes a memory 221, a RAID control unit 222, and a cache control unit 224.

The memory 221 can be used as a disk cache for temporarily storing data received from the host 250 via the CAs 210. Moreover, a program executed by a CPU, which is included in the storage system 200 and not illustrated, can be stored in the memory 221 in order to implement the RAID control unit 222 and the cache control unit 224. Moreover, an aggregate management table 221a, a RAID management table 221b, a disk group management table 221c, and a write management table 221d, and the like can be stored in the memory 221. For example, a nonvolatile memory such as a RAM (Random Access Memory) or the like can be used as the memory 221.

The RAID control unit 222 performs a control for generating a RAID group including some or all of disks in the disk group 230, and for reading/writing data from/to a RAID group. The RAID control unit 222 generates an aggregation of RAID groups called an “aggregate”, and can use the generated aggregate as one logical pool. Moreover, the RAID control unit 222 can provide a virtual volume to the host 250 by using some or all of storage resources included in the aggregate.

The RAID control unit 222 includes a disk control unit 223. The RAID control unit 222 can execute the disk control unit 223 and stop the disk control unit 223 according to an instruction issued from a user, or setting information stored in a nonvolatile memory or the like not illustrated. The RAID control unit 222 can implement the storage system 200 according to this embodiment to be described later with reference to FIGS. 9-11 by executing the disk control unit 223. Furthermore, the RAID control unit 222 can cause a storage system to operate as a general storage system without dividing the RAID groups as in this embodiment by stopping the disk control unit 223.

The disk control unit 223 generates disk groups by dividing disks included in a RAID group within the disk group 230 into a plurality of groups. Then, the disk control unit 223 powers off disk groups other than a disk group that satisfies a specified condition among the generated disk groups. Moreover, the disk control unit 223 reads/writes data from/to a disk group by a request issued from the data control unit 225.

The cache control unit 224 performs a control for implementing a disk cache with the memory 221, such as for temporarily storing data and storing data in a RAID group within the disk group 230 when needed. Moreover, the cache control unit 224 includes the data control unit 225.

The data control unit 225 performs striping for written data in a specified stripe size when the data is written to a disk group included in a RAID group within the disk group 230. Then, the data control unit 225 generates data groups by dividing the striping data into groups by the number of disks included in the disk group. In this embodiment, striping data included in a data group is distributed and stored on disks included in a disk group. For example, when a data group including striping data #1 and #2 is written to a disk group including disks #1 and #2, the striping data #1 and #2 are respectively distributed and stored on the disks #1 and #2.

The data control unit 225 generates, for each of disks, a data list, in which the order of striping data written to a disk is rearranged, in order to sequentially write the striping data to each of the disks of a disk group included in a RAID group within the disk group 230. The data control unit 225 requests the disk control unit 223 to write the data based on the generated data list.

The disk group 230 may include a plurality of storage devices. As a storage device included in the disk group 230, a magnetic disk device such as a hard disk or the like may be used. A storage device included in the disk group 230 is referred to simply as a “disk” throughout the explanation of this embodiment.

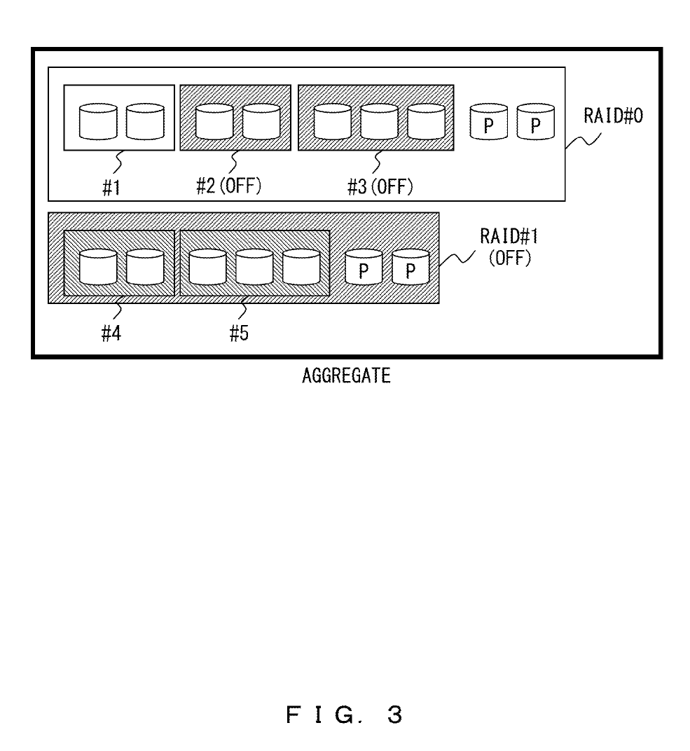

FIG. 3 is an explanatory diagram of operations of the disk control unit 223. FIG. 3 illustrates a case were two RAID groups are generated by using disks included in the disk group 230. RAID #0 is a RAID-DP using seven disks for data and two disks for parity. Moreover, RAID #1 is a RAID-DP using five disks for data and two disks for parity. The RAID #0 and the RAID #1 are gathered as an aggregate.

For example, when the storage system 200 is activated or when a user performs a specified operation for the storage system 200 via an input device, the disk control unit 223 generates a plurality of disk groups by dividing disks included in a RAID group into groups. FIG. 3 illustrates the case where three disk groups #1-#3 are generated by dividing the disks included in the RAID #0 into groups. The disk control unit 223 according to this embodiment excludes parity disks from grouping targets. This is because the RAID #0 cannot operate as a RAID-DP if the parity disks are configured as a target to be powered off by being divided as a group.

The disk control unit 223 powers off disk groups other than a disk group that satisfies a particular condition among generated disk groups after the disc control unit 223 has generated the disk groups. In this case, all disks included in a RAID group that does not include the disk group satisfying the particular condition are powered off. For example, in FIG. 3, the disc group #1 in the RAID #0 satisfies the particular condition and the RAID #1 is powered off. As the disk group that satisfies the particular condition, a disk group having the highest write priority specified for each disk group may be selected. FIG. 3 illustrates the case where disks of the disk groups #2 and #3 other than the disk group #1 and the RAID #1 are powered off.

Note that the discs for parity are not powered off in RAID #0, since RAID #0 includes the disc group which satisfies the particular condition. On the other hand, all discs including a disc for parity are powered off in RAID #1, since RAID #1 does not include a disc group which satisfies the particular condition.

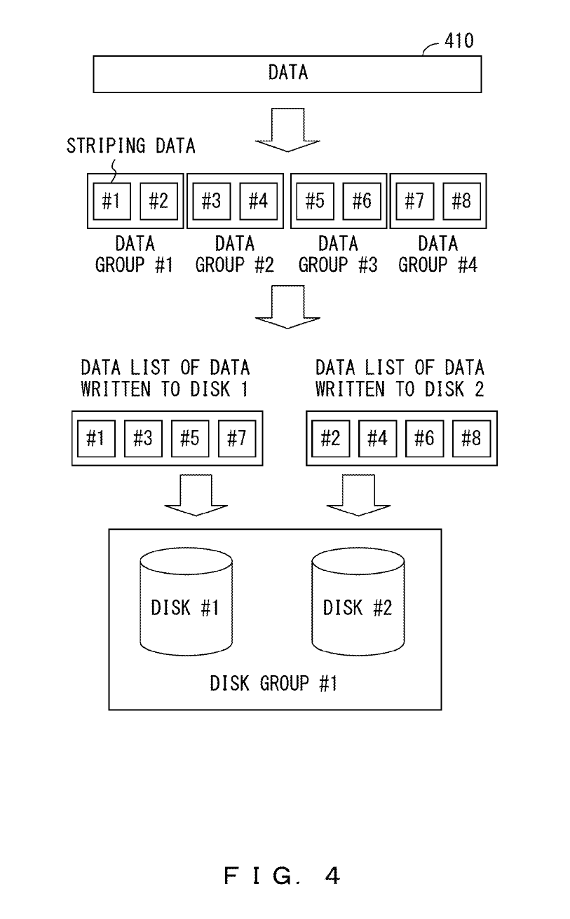

FIG. 4 is an explanatory diagram of operations of the data control unit 225. FIG. 4 illustrates a process for reading data 410 that is received from the host 250 and stored in the memory 221, and for writing the data 410 to the disk group #1 included in the RAID #0 illustrated in FIG. 3.

The data control unit 225 partitions the data 410 into striping data of a specified size. Then, the data control unit 225 generates data groups by dividing the striping data into groups by the number of used disks of a disk group at a write destination of the data 410, namely, by each number of disks included in the disk group. In FIG. 4, the data control unit 225 partitions the data 410 into 8 striping data #1-#8. Moreover, the data control unit 225 generates data groups #1-#4 by dividing the striping data #1-#8 into groups in units of 2 data since the disk group #1 includes 2 disks.

In this embodiment, striping data included in a data group is distributed and stored on disks included in a disk group at a write destination. For example, in the case of FIG. 4, striping data #1 and #2 of the data group #1 are respectively stored on the disks #1 and #2 of the disk group #1. Similarly, striping data #3 and #4 of the data group #2 are respectively stored on the disks #1 and #2 of the disk group #1.

Accordingly, the data control unit 225 generates a data list, in which the order of striping data is rearranged, in order to sequentially write the striping data to each of disks at a write destination. In FIG. 4, the data control unit 225 generates a data list of striping data, in which the striping data is rearranged in the order where the data is written to the disk #1 included in the disk group #1. Similarly, the data control unit 225 generates a data list of striping data, in which the striping data is rearranged in the order where the data is written to the disk #2 included in the disk group #1.

The data control unit 225 requests the disk control unit 223 to write the striping data #1-#8 to the disk group #1 based on the data list after the data control unit 225 has generated the data list. The disk control unit 223 that has received the request sequentially writes the striping data to the disks at the write destination based on the data list. For example, the disk control unit 223 sequentially writes the striping data #1, #3, #5, and #7 to the disk #1 in this order. Similarly, for example, the disk control unit 223 sequentially writes striping data #2, #4, #6, and #8 to the disk #2 in this order.

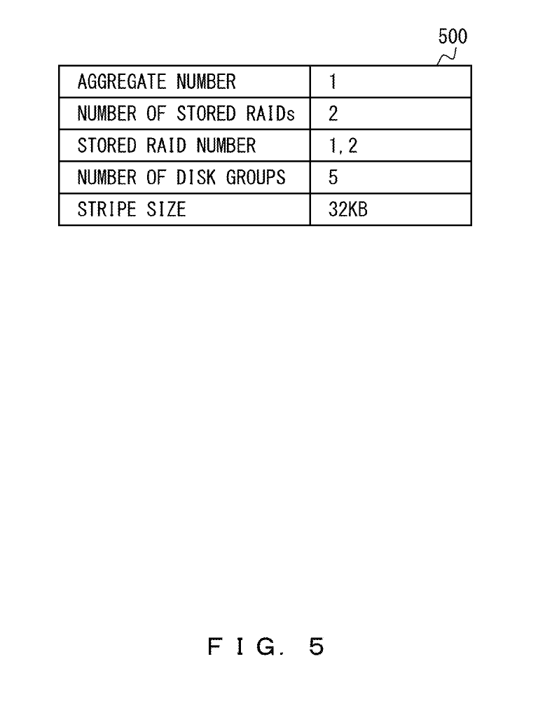

FIG. 5 illustrates an example of the aggregate management table 221a. The aggregate management table 221a is prepared for each aggregate. An aggregate management table 500 illustrated in FIG. 5 includes information about an aggregate number, the number of stored RAIDs, a stored RAID number, the number of disk groups, and a stripe size. The aggregate management table 221a may be prepared for each aggregate.

The aggregate number is identification information assigned to each aggregate. The number of stored RAIDs is information indicating the number of RAID groups included in an aggregate. The stored RAID number is information indicating a RAID number of a RAID group included in the aggregate. The RAID number is identification information assigned to each RAID group. The number of disk groups is information indicating the total number of disk groups included in a RAID group within the aggregate. The stripe size is a size in which striping is performed for data received from the host 250.

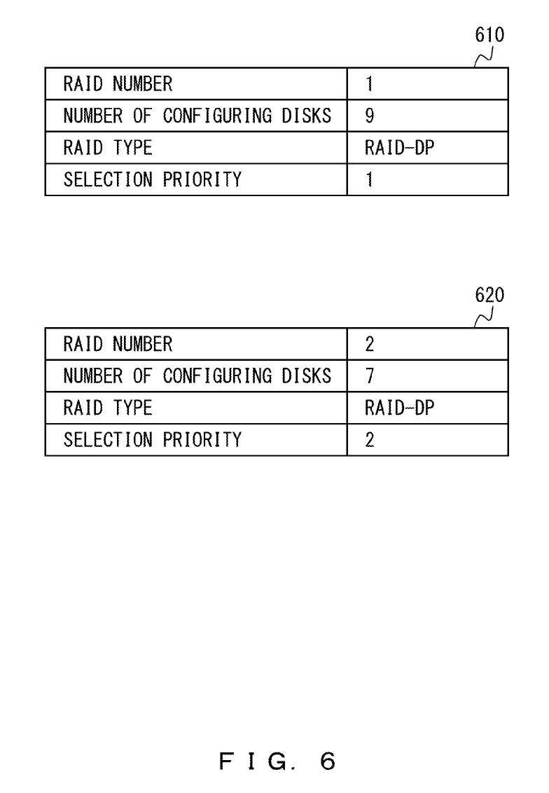

FIG. 6 illustrates an example of the RAID management table 221b. The RAID management table 221b may be prepared for each RAID group. RAID management tables 610 and 620 illustrated in FIG. 6 respectively represent RAID management tables of the RAIDs #0 and #1 illustrated in FIG. 3. Since both of the RAID management tables have substantially the same configuration, the RAID management table 610 is described below.

The RAID management table 610 illustrated in FIG. 6 includes information about a RAID number, the number of configuring disks, a RAID type, and a selection priority. The RAID number is identification information assigned to each RAID group. The number of configuring disks is information indicating the number of disks included in a RAID group. The RAID type is information indicating a type of a RAID group, such as a RAID-DP, or the like. The selection priority is information indicating a priority selected at a data write.

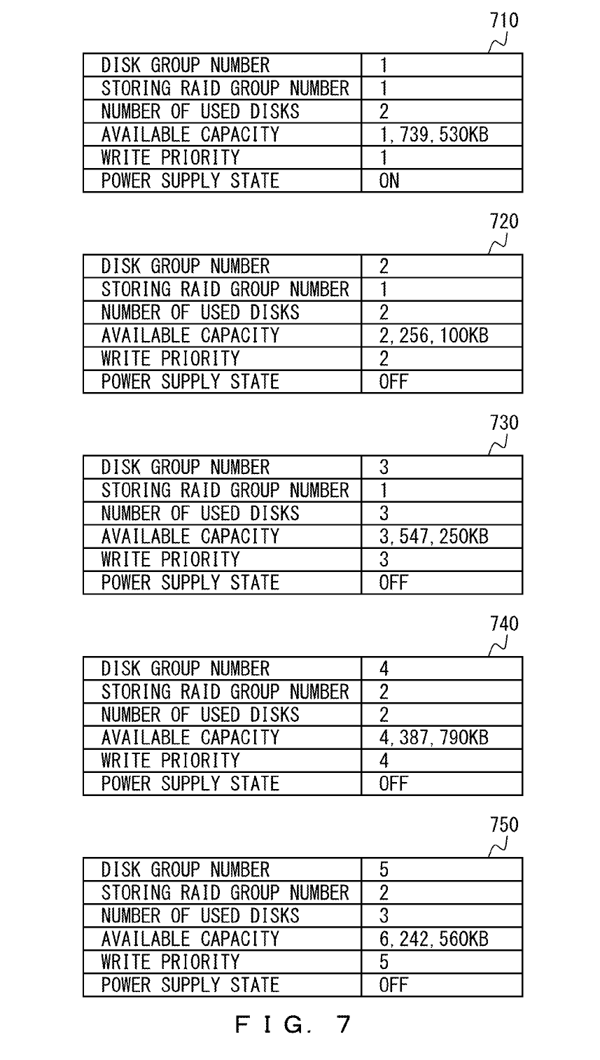

FIG. 7 illustrates an example of the disk group management table 221c. The disk group management table 221c may be prepared for each disk group. The disk group management tables 710-750 illustrated in FIG. 7 represent disk group management tables of the disk groups #1-#5 included in the RAIDs #0 and #1 illustrated in FIG. 3. Since all the disk group management tables have substantially the same configuration, the disk group management table 710 is described below.

The disk group management table 710 illustrated in FIG. 7 may include information about a disk group number, a storing RAID group number, the number of used disks, an available capacity, a write priority, and a power supply state.

The disk group number is identification information assigned to each disk group. The disk group number according to this embodiment is a serial number of all disk groups. In the example of FIG. 7, disk group numbers #1-#3 are respectively assigned to three disk groups included in the RAID #0, whereas disk group numbers #4-#5 are respectively assigned to two disk groups included in the RAID #1.

The storing RAID group number is information indicating a RAID number of a RAID group including disk groups. The number of used disks is information indicating the number of disks included in a disk group. The available capacity is information indicating an available capacity of a disk group. The write priority is information indicating a priority with which data is written. The power supply state is information indicating whether a power supply of a disk group is either in an ON or OFF state.

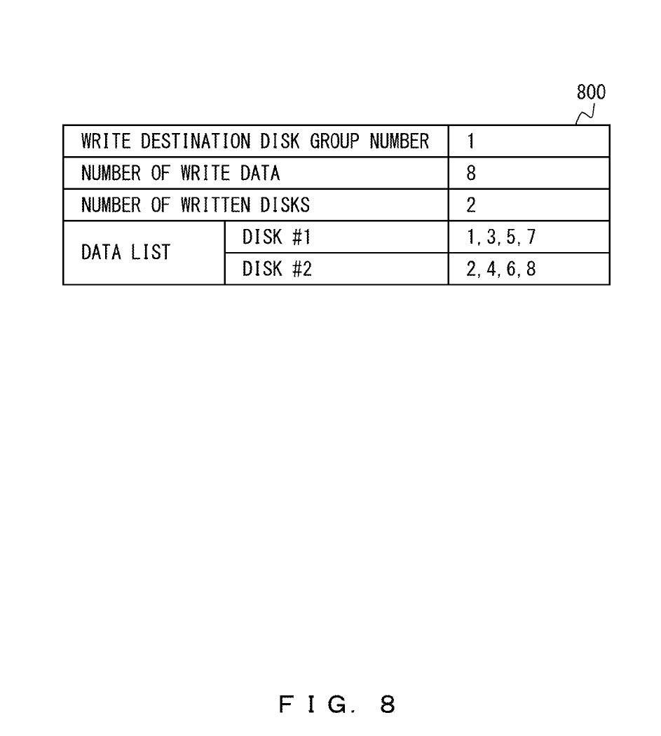

FIG. 8 illustrates an example of the write management table 221d. The write management table 800 illustrated in FIG. 8 may include information about a write destination disk group number, the number of write data, the number of written disks, and a data list.

The write destination disk group number is a disk group number of a disk group as a write target. The number of write data is information indicating the number of striping data generated by performing striping for write data to be written to a disk group as a write target. The number of written disks is information indicating the number of disks included in a disk group as a write target. The data list is a data list indicating the order of writing data to a disk for each of disks included in a disk group as a write target.

FIG. 9 is a flowchart illustrating a disk group generation process executed by the disk control unit 223. For example, when a user performs a specified operation for the storage system 200 via an input device, the disk control unit 223 starts the disk group generation process for an aggregate specified by the user (step S900). The aggregate specified by the user is hereinafter referred to as a “target aggregate”.

The disk control unit 223 references the aggregate management table 221a of the target aggregate, which is stored in the memory 221. Then, the disk control unit 223 obtains a RAID number of a RAID group to be processed from a field of the stored RAID number in the aggregate management table 221a (step S901). The disk control unit 223 according to this embodiment obtains all RAID numbers registered as stored RAID numbers in the aggregate management table 221a. Then, the disk control unit 223 selects one of the obtained RAID numbers. Hereinafter, the RAID group having the selected RAID number is referred to as a “target RAID group”, and a RAID number of the target RAID group is referred to as a “target RAID number”.

The disk control unit 223 obtains the number of configuring disks and a RAID type from the RAID management table 221b, which is stored in the memory 221, of the target RAID group, namely, the RAID management table 221b having a RAID number that matches the target RAID number (step S902).

The disk control unit 223 calculates the number of disk groups of the target RAID group based on the number of configuring disks and the RAID type, which have been obtained in step S902 (step S903). For the calculation of the number of disk groups, the following expression (1) may be used.

{(the number of configuring disks)−(the number of parity disks)}/(the number of used disks) (1)

where “the number of configuring disks” is the number of configuring disks obtained in step S902, “the number of parity disks” is the number of parity disks used in the RAID group of the RAID type obtained in step S902, and “the number of used disks” is the number of disks used in a disk group. “the number of used disks” may be determined in advance. “the number of used disks” according to this embodiment is assumed to be 2, although it is not particularly limited.

For example, when the target RAID group is the RAID group having the RAID number #1, the disk control unit 223 obtains “9” and “RAID-DP” respectively as the number of configuring disks and the RAID type from the RAID management table 610 illustrated in FIG. 6. The number of parity disks used in a RAID-DP is “2”. Therefore, the disk control unit 223 calculates the number of disk groups to be 3.5(=(9−2)/2) by using the above provided expression (1). Since a fractional portion is rounded down in this embodiment, the disk control unit 223 obtains the number of disk groups “3”.

The disk control unit 223 divides disks included in the target RAID group into disk groups by the number of disk groups obtained in step S903 (step S904). Moreover, the disk control unit 223 assigns a disk group number and a write priority to each of the disk groups generated by dividing the disks into groups. For example, the disk control unit 223 sequentially assigns disk group numbers #1, #2, #3, . . . to the generated disk groups in the order where the disk groups are generated. Similarly, the disk control unit 223 sequentially assigns write priorities 1, 2, 3, . . . to the generated disk groups in the order where the disk groups are generated. In this case, the write priority “1” is the highest, and the write priorities “2”, “3”, . . . descends in this order. However, the assignments of disk group numbers and write priorities are not limited to the order where disk groups are generated. Disk group numbers and write priorities may be assigned to disk groups based on various policies when needed.

The disk control unit 223 generates the disk group management table 221c for each of the disk groups generated in step S904, and stores the disk group management table 221c in the memory 221. Then, the disk control unit 223 writes a storing RAID group number, the number of used disks, and a power supply state in each generated disk group management table 221c (step S905). Moreover, the disk control unit 223 writes the write priority assigned in step S904 to each generated disk group management table 221c (step S905).

The disk control unit 223 calculates an available capacity based on a capacity of a used storage area for each of the disk groups generated in step S904, and writes the calculated capacity to the disk group management table 221c (step S906).

The disk control unit 223 powers off disk groups other than the disk group having the write priority “1” assigned in step S904 among the disk groups included in the target RAID group (step S907). Moreover, the disk control unit 223 powers off disks included in RAID groups other than the target RAID group (step S907). The disk control unit 223 writes an OFF state to a field of the power supply state of the disk group management table 221c of each of the disk groups that have been powered off.

If a RAID group for which the processes of steps S902-S907 are not executed is included in a target aggregate (“YES” in step S908), the process of the disk control unit 223 moves to step S902. Then, the disk control unit 223 repeats the processes of steps S902-S908. When the processes of steps S902-S907 have been executed for all the RAID groups included in the target aggregate (“NO” in step S908), the disk control unit 223 terminates the disk group generation process (step S909).

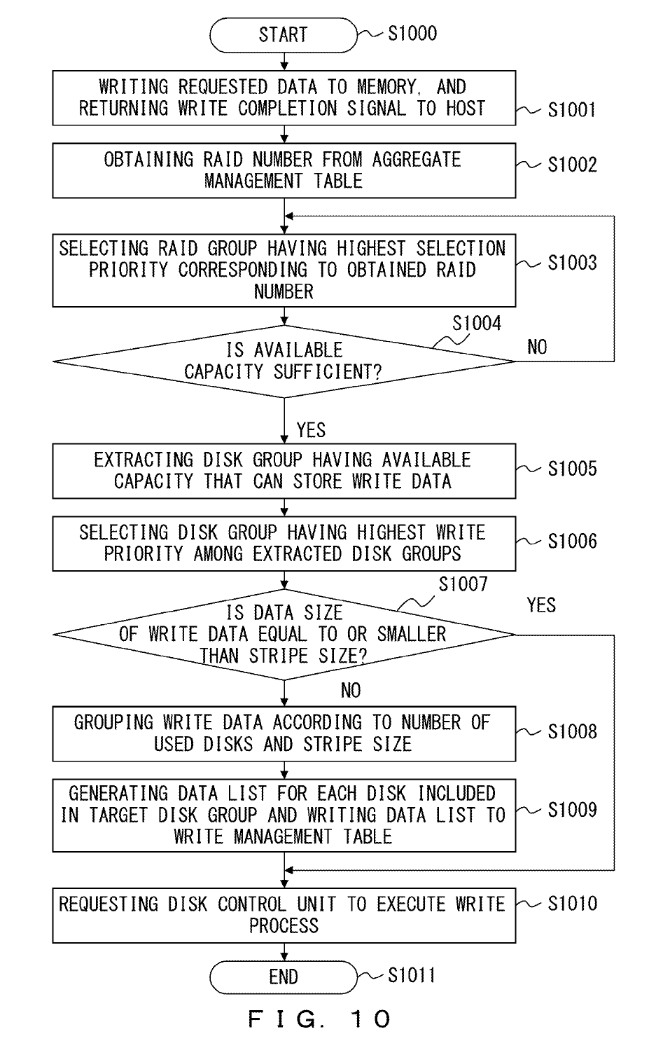

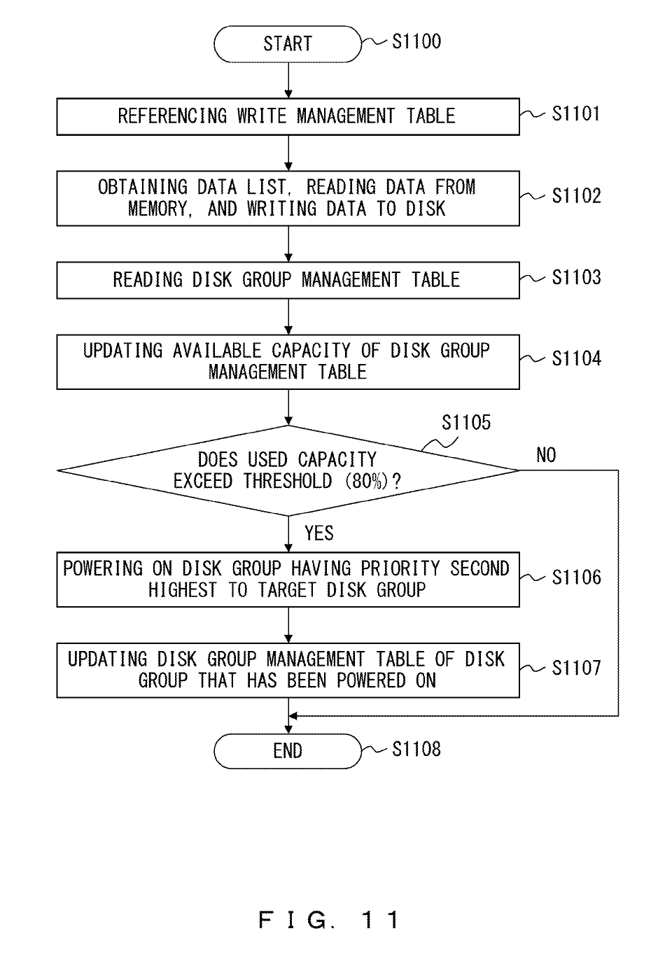

The data write process according to this embodiment is executed by the data control unit 225 and the disk control unit 223. The write process executed on the data control unit 225 is described below with reference to FIG. 10, whereas that executed on the disk control unit 223 is described below with reference to FIG. 11.

FIG. 10 is a flowchart illustrating the write process executed on the data control unit 225. Upon receipt of a data write request from the host 250, the data control unit 225 starts the following process (step S1000).

The data control unit 225 writes, to the memory 221, data that the host 250 has requested to write, and returns a write completion signal of the data to the host 250 (step S1001). The data that the host 250 has requested to write is hereinafter referred to as “write data”.

The data control unit 225 obtains a RAID number registered as a stored RAID number in the aggregate management table 221a by referencing the aggregate management table 221a (step S1002). Then, the data control unit 225 selects a RAID group having the highest selection priority set in the RAID management table 221b among RAID groups having the RAID number obtained in step S1002 (step S1003).

When an available capacity is not sufficient for the RAID group selected in step S1003 (“NO” in step S1004), the data control unit 225 selects a RAID group by re-executing step S1003. In this case, a RAID group already selected in step S1003 is excluded from selection targets.

When the available capacity is sufficient for the RAID group selected in step S1003 (“YES” in step S1004), the process of the data control unit 225 moves to step S1005. In this case, the data control unit 225 references a disk group management table 221c of each of disk groups included in the RAID group selected in step S1003, and extracts a disk group having an available capacity that can store write data (step S1005). Then, the data control unit 225 selects a disk group having the highest write priority included in the disk group management table 221c from among disk groups extracted in step S1005 (step S1006).

When the data size of the write data is equal to or smaller than a stripe size (“YES” in step S1007), the process of the data control unit 225 moves step S1010. When the data size of the write data is larger than the stripe size (“NO” in step S1007), the process of the data control unit 225 moves to step S1008. In this case, the data control unit 225 generates data groups by dividing the write data into groups according to the number of used disks and the stripe size (step S1008). In this embodiment, striping is performed for write data in a stripe size, and striping data is divided into groups by the number of used disks.

The data control unit 225 generates a data list for each of disks included in the disk group as a write target, which is selected in step S1006, and writes the data list to a field of the data list in the write management table 221d (step S1009). In this data list, the order of striping data included in a data group generated in step S1008 is rearranged in order to sequentially write the data to a disk.

Additionally, in the process of step S1009, the data control unit 225 writes values also to the write destination disk group number, the number of write data, and the number of written disks. To the write destination disk group number in the write management table 221d, a number of the disk group selected in step S1006 is written. To the number of write data in the write management table 221d, the number of striping data generated by performing the striping in step S1008 is written. To the number of written disks in the write management table 221d, the number of used disks of the disk group selected in step S1006 is written.

Upon termination of the above described processes, the data control unit 225 requests the disk control unit 223 to execute the write process (step S1010), so that the write process executed on the data control unit 225 is terminated (step S1011).

FIG. 11 is a flowchart illustrating the write process executed on the disk control unit 223. Upon receipt of the write request from the data control unit 225, the disk control unit 223 starts the write process (step S1100).

The disk control unit 223 references the write management table 221d stored in the memory 221 (step S1101). At this time, the disk control unit 223 can identify the disk group as a data write target based on the write destination disk group number in the write management table 221d. The disk group as a write target is hereinafter referred to as a “target disk group”.

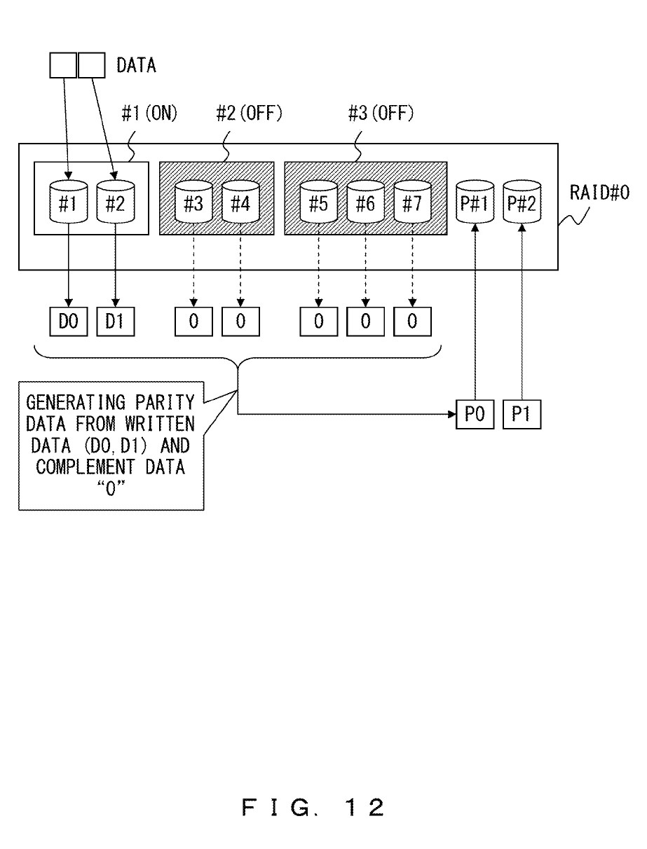

The disk control unit 223 obtains a data list for each of disks within the target disk group from the write management table 221d (step S1102). Then, the disk control unit 223 reads, from the memory 221, the striping data in order where the data is registered to the data list, and writes the read data to disks within the target disk group (step S1102). Generation of parity at a data write will be described later with reference to FIG. 12.

The disk control unit 223 reads the disk group management table 221c of the target disk group (step S1103). Then, the disk control unit 223 calculates an available capacity after the data has been written in step S1102 by subtracting the amount of data written in step S1102 from the available capacity included in the read disk group management table 221c. Then, the disk control unit 223 updates the available capacity of the disk group management table 221c to the calculated available capacity (step S1104).

When the used capacity of the target disk group exceeds a threshold, for example, when a ratio of the used capacity to the entire storage capacity of the target disk group exceeds 80 percent (“YES” in step S1105), the process of the disk control unit 223 moves to step S1106. In this case, the disk control unit 223 identifies a disk group having a priority second highest to the target disk group by referencing the disk group management table 221c. Then, the disk control unit 223 powers on the disk group having the priority second highest to the target disk group (step S1106). When the disk group that has been powered on belongs to a RAID group different from the target disk group and when a parity disk is included in the RAID group to which the disk group belongs, the disk control unit 223 powers on also the parity disk. Note that the used capacity of the target disk group can be obtained by subtracting the available capacity calculated in step S1104 from the entire capacity of the target disk group.

The disk control unit 223 updates information about the power supply state of the disk group management table 221c of the disk group that has been powered on in step S1106 to an ON state (step S1107).

Upon completion of the update of the disk group management table 221c, the process of the disk control unit 223 moves to step S1108. Moreover, when the used capacity of the target disk group is equal to or smaller than the threshold (“NO” in step S1105), the process of the disk control unit 223 also moves to step S1108. Then, the disk control unit 223 terminates the write process (step S1108).

FIG. 12 is an explanatory diagram for parity generation at a data write in step S1102. In this embodiment, a disk group that is in a power-off state is sometimes included in a RAID group. FIG. 12 explains a parity generation process executed when data is written to the RAID #0 illustrated in FIG. 3.

The RAID #0 illustrated in FIG. 12 includes three disk groups #1-#3. The disc group #1 is in a power-on state, and the disk groups #2 and #3 are in a power-off state. In this case, the disk control unit 223 distributes and writes data to the disks #1 and #2 within the disk group #1 by a request issued from the data control unit 225. Assume that the data written to the disks #1 and #2 at this time are D0 and D1, respectively.

Since the RAID #0 illustrated in FIG. 12 configures a RAID-DP, parity is generated from the data written to the disks #1-#7. In the example of FIG. 12, however, the disk groups #2 and #3 are in a power-off state. This embodiment assumes that “0” is respectively written to the disks #3-#7 included in the disk groups #2 and #3 that are in the power-off state. Namely, the disk control unit 223 generates parity data by complementing “0”, which assumes that data has been written to the disks #3-#7, to the data D0 and D1 respectively written to the disks #1 and #2. In other words, the parity data may be generated from “D0, D1, 0, 0, 0, 0, 0”. The disk control unit 223 respectively stores the generated parity data P0 and P1 on the parity disks P#1 and P#2.

As described above, this embodiment assumes that “0” is written to disks included in a disk group that is in a power-off state at a data write. This is based on the configuration in which “0” is written to disks by executing a process of zero-padding for each of the disks included in a generated RAID group when the RAID group is generated.

The above embodiments have been described by taking, as an example, the case where a RAID group is a RAID-DP. However, a RAID group available in this embodiment is not limited to a RAID-DP. For example, the RAID group may be a RAID group, such as a RAID 4 or a RAID 0+1, which is configured by including data disks and a parity disk or configured by only data disks.

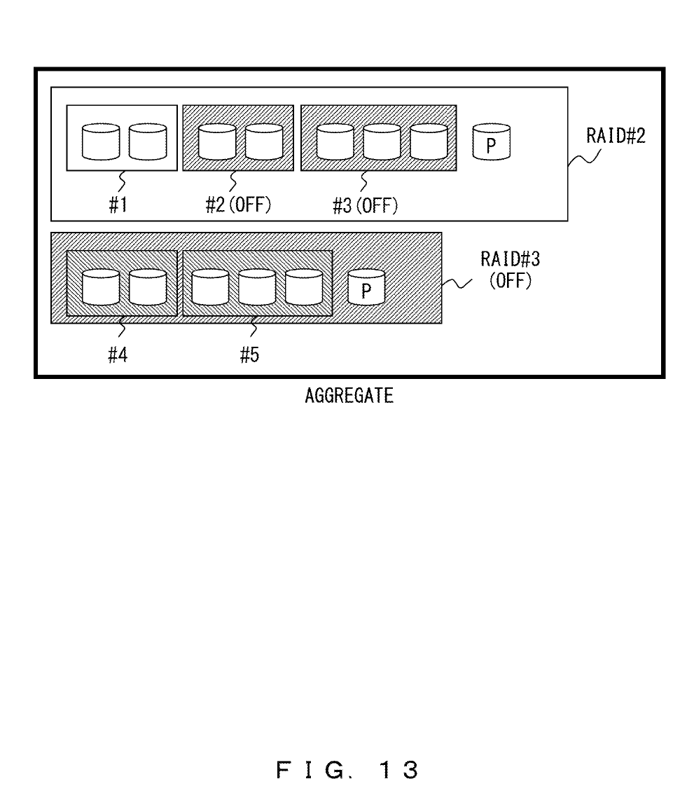

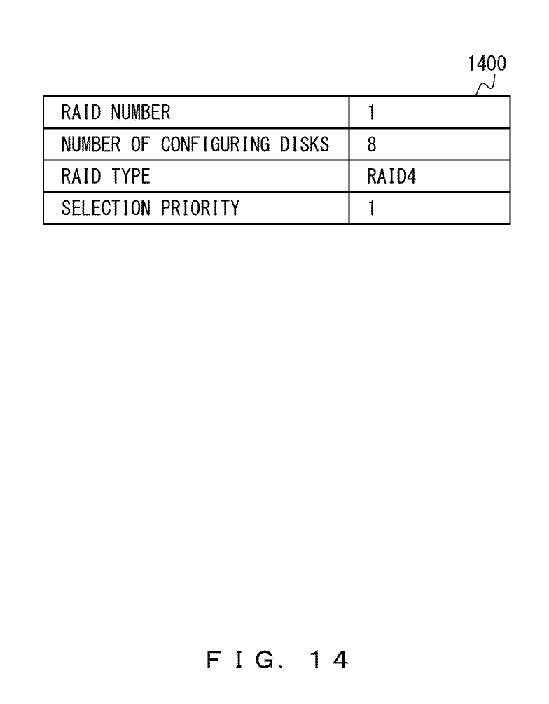

FIG. 13 illustrates an example of an aggregate including a RAID group of RAID 4. In this case, “RAID 4” is set as a RAID type in the RAID management table 221b as represented by a RAID management table 1400 illustrated in FIG. 14. Since the RAID 4 includes one parity disk, for example, the disk control unit 223 calculates the number of disk groups by substituting “1” for (the number of parity disks) in the expression (1) when the number of disk groups is calculated in step S902 illustrated in FIG. 9. Since the other operations are similar to those described with reference to FIGS. 2-12, their explanations are omitted.

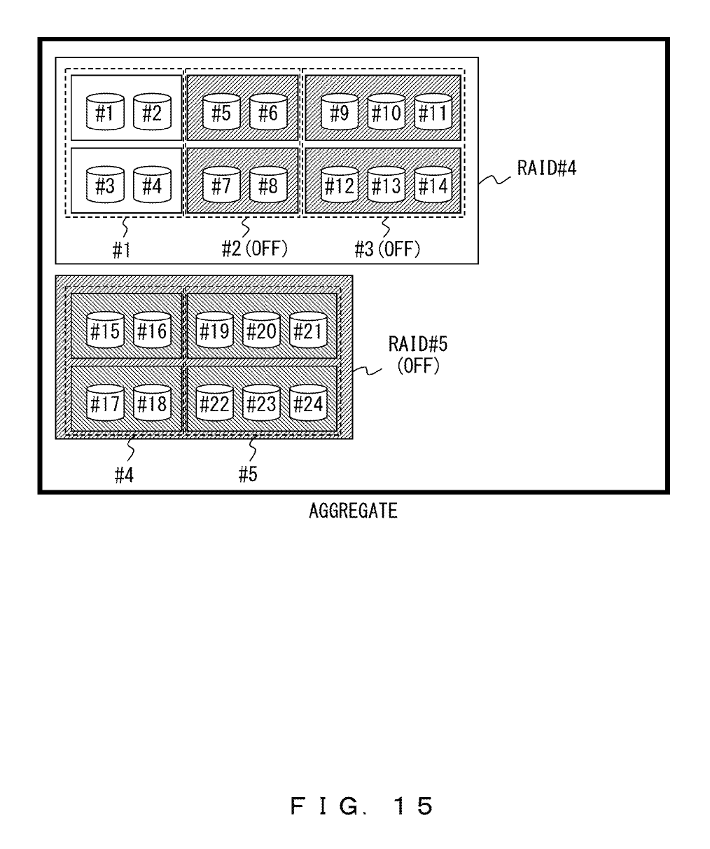

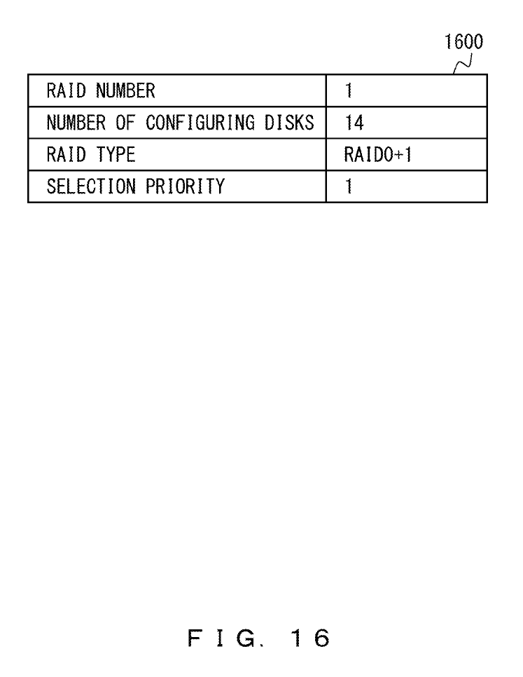

FIG. 15 illustrates an example of an aggregate including a RAID group of RAID 0+1. For example, the RAID #0 is RAID 0+1 implemented by duplicating disks #1 to #2, #5 to #6, and #9 to #11, and disks #3 to #4, #7 to #8, and #12 to #14. Similarly, the RAID #1 is RAID 0+1 implemented by duplicating disks #15 to #16 and #19 to #21, and disks #17 to #18, and #22 to #24. In this case, “RAID 0+1” is set as a RAID type in the RAID management table 221b as represented by a RAID management table 1600 illustrated in FIG. 16. Since the RAID 0+1 does not include a parity disk, for example, the disk control unit 223 calculates the number of disk groups by substituting “0” for (the number of parity disks) in the expression (1) when the number of disk groups is calculated in step S902 illustrated in FIG. 9.

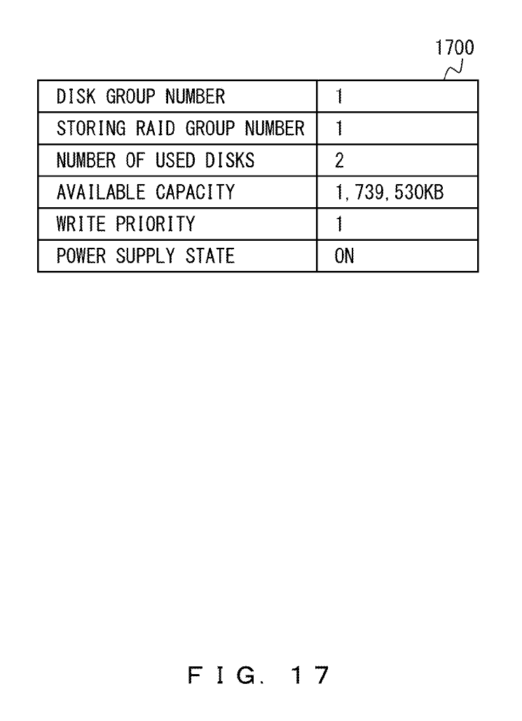

As the number of used disks in the disk group management table 221c, a value obtained by counting duplicated disks as one disk is used. For example, the disk group #1 illustrated in FIG. 15 includes 4 disks. However, the disks #1 and #3, and #2 and #4 are counted as 2 disks since these disks are duplicated. In this case, the number of used disks is 2 as represented by a disk group management table 1700 illustrated in FIG. 17.

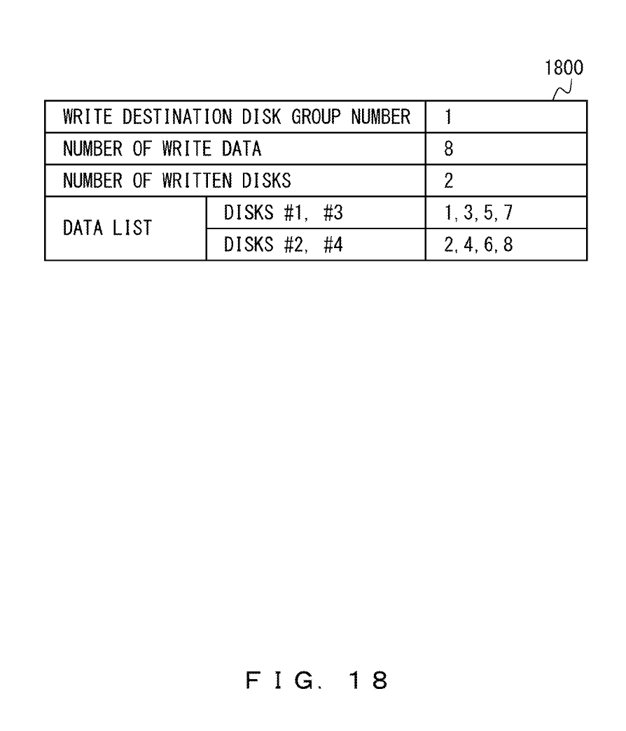

Additionally, for example, when data is written to the disk group #1 illustrated in FIG. 15, the same data is written to the disks #1 and #3, and #2 and #4, respectively. In this case, in step S1009, the data control unit 225 registers a data list for the disks #1 and #3, and the disks #2 and #4 as represented by a write management table 1800 illustrated in FIG. 18. Since the other operations are similar to those described with reference to FIGS. 2-12, their explanations are omitted.

The storage system 200 divides data disks included in a RAID group into a plurality of disk groups. Then, the storage system 200 powers off disk groups other than a disk group having the highest write priority. As a result, the storage system 200 can reduce power consumed by the storage system 200.

The storage system 200 divides striping data into a plurality of data groups when the data is written to a disk group. Then, the storage system 200 respectively distributes and stores each of the data groups to disks within the disk group. At this time, the storage system 200 generates a data list where the striping data included in each of the data groups is rearranged for each of the written disks. Then, the storage system 200 writes the data to the disks within the disk group based on the generated data list. As a result, the storage system 200 writes the striping data included in each of the data groups to the disks at a write destination of the striping data as sequential data.

In a storage system implemented with the AOU technique, storage area allocation and power supply control are performed in units of disks. Therefore, accesses may concentrate on a certain disk. Accordingly, access performance of the storage system is sometimes reflected unchanged as that of a disk. The storage system 200 according to this embodiment, however, performs a power supply control in units of disk groups each including a plurality of disks. As a result, even if accesses concentrate on one disk group, data is distributed and stored on disks within the disk group. Consequently, performance of a data access can be avoided from being degraded.

As described above, the disclosed storage system can reduce power consumption.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system, comprising:
a grouping unit configured to generate one or more storage device sub-groups, each of the storage device sub-groups including a storage device used to store data, from storage devices included in a plurality of storage device groups that respectively include a plurality of storage devices;
a selection unit configured to select any of the one or more storage device sub-groups; and
a control unit configured to shut off power supply to a non-selected device group, which is a storage device sub-group other than a selected storage device sub-group and included in a storage device group including the selected storage device sub-group, and shut off power supply to storage devices included in a storage device group other than the storage device group including the selected storage device sub-group.

2. The storage system according to claim 1, wherein
the control unit aggregates the storage device groups, and provides one or more logical volumes to a higher-level device by using storage resources included in the aggregated storage device groups.

3. The storage system according to claim 1, wherein
the control unit supplies power to any of the storage device sub-groups other than the selected storage device sub-group when a used capacity within a storage capacity of the selected storage device sub-group exceeds a specified threshold.

4. The storage system according to claim 1, further comprising
a storage processing unit configured to generate striping data by partitioning data from a higher-level device, to generate data groups by dividing the striping data into groups according to the number of storage devices included in the selected storage device sub-group, and to distribute the striping data included in the generated data groups to storage devices included in the selected storage device sub-group.

5. The storage system according to claim 4, wherein
the storage processing unit extracts striping data from each of the data groups for each of the storage devices at a write destination, and sequentially writes the extracted striping data to the storage devices at the write destination.

6. The storage system according to claim 5, wherein
the storage processing unit generates a data list by extracting striping data from each of the data groups for each of the storage devices at the write destination and by rearranging the striping data in the order of writing the data, and sequentially writes the striping data to the storage devices at the write destination based on the generated data list.

7. The storage system according to claim 1, wherein
the grouping unit decides the number of storage device sub-groups according to the number of storage devices included in a storage device group and a type of the storage device group.

8. The storage system according to claim 1, wherein
the selection unit selects a storage device sub-group according to priorities respectively assigned to the storage device sub-groups.

9. A storage control method, comprising:
generating, by a processor, one or more storage device sub-groups, each of the storage device sub-groups including a storage device used to store data, from storage devices included in a plurality of storage device groups that respectively include a plurality of storage devices;
selecting, by the processor, any of the one or more storage device sub-groups; and
shutting off, by the processor, power supply to a non-selected device group, which is a storage device sub-group other than a selected storage device sub-group and included in a storage device group including the selected storage device sub-group, and shutting off power supply to storage devices included in a storage device group other than the storage device group including the selected storage device sub-group.

10. A computer-readable recording medium having stored therein a program for causing a computer to execute a storage control process comprising:
generating one or more storage device sub-groups, each of the storage device sub-groups including a storage device used to store data, from storage devices included in a plurality of storage device groups that respectively include a plurality of storage devices;
selecting any of the one or more storage device sub-groups; and
shutting off power supply to a non-selected device group, which is a storage device sub-group other than a selected storage device sub-group and included in a storage device group including the selected storage device sub-group, and shutting off power supply to storage devices included in a storage device group other than the storage device group including the selected storage device sub-group.
